(19) United States
(12) Patent Application Publication
(10) Pub. No.: US 2022/0271908 A1
(43) Pub. Date: Aug. 25, 2022

(54) TDD (TIME DIVISION DUPLEX) RADIO CONFIGURATION FOR REDUCTION IN TRANSMIT AND RECEIVE PATH RESOURCES

(71) Applicant: Meta Platforms, Inc., Menlo Park, CA (US)

(72) Inventors: Kodanda Ram Reddy Engala, Irving, TX (US); Farbod Tabatabai, San Francisco, CA (US); Imad Shehab, La Jolla, CA (US)

(21) Appl. No.: 17/179,576

(22) Filed: Feb. 19, 2021

(51) Int. Cl. H04L 5/14; H04B 1/44

(52) U.S. Cl. CPC H04L 5/14; H04B 1/44

(57) ABSTRACT

Apparatuses, methods, and systems for a TDD (time division duplex) radio configuration for reduction in transmit and receive path resources are disclosed. One system includes an RF system on a chip (RFSOC) comprising baseband communication circuitry and frequency upconverters for transmit wireless signals and frequency downconverters for received wireless signals, a transmit switch receiving a plurality of transmit signals from the RFSOC through single transmit line, and operative to connect each of the plurality of transmit signals to a one of a plurality of antennas, one at a time, continuously over time, and a receive switch receiving a plurality of receive signals from the plurality of antennas, and operative to connect each of the plurality of receive signals to the RFSOC on a single receive line, one at a time, continuously over time, wherein each antenna of the plurality of antennas is either transmitting or receiving.

### FIELD OF THE DESCRIBED EMBODIMENTS

The described embodiments relate generally to wireless communications. More particularly, the described embodiments relate to systems, methods and apparatuses for a TDD (time division duplex) radio configuration for reduction in transmit and receive path resources.

### BACKGROUND

Current TDD remote radio unit (RRU) and mMIMO (massive multi-input, multi-output) base stations have one dedicated LPTX (low power Transmit) path and corresponding one dedicated RX (receiver) path for each antenna. Only one path (Tx or RX) can be used at a time in TDD (time division duplex) systems.

It is desirable to have methods, apparatuses, and systems for a TDD (time division duplex) radio configuration for reduction in transmit and receive path resources.

### SUMMARY

An embodiment includes a transceiver system. The transceiver system includes an RF system on a chip (RFSOC) comprising baseband communication circuitry and frequency upconverters for transmit wireless signals and frequency downconverters for received wireless signals. The system further includes a transmit switch receiving a plurality of transmit signals from the RFSOC through single transmit line, and operative to connect each of the plurality of transmit signals to a one of a plurality of antennas, one at a time, continuously over time, and a receive switch receiving a plurality of received signals from the plurality of antennas, and operative to connect each of the plurality of received signals to the RFSOC on a single receive line, one at a time, continuously over time, wherein each antenna of the plurality of antennas is either transmitting or receiving.

Another embodiment includes a method. The method includes frequency upconverting and frequency down-converting, by an RF system on a chip (RFSOC), transmit and received wireless signals, receiving, by a transmit switch, a plurality of transmit signals from the RFSOC through single transmit line, connecting each of the plurality of transmit signals to a one of a plurality of antennas, one at a time, continuously over time, and receiving, by a receive switch, a plurality of received signals from the plurality of antennas, and connecting each of the plurality of received signals to the RFSOC on a single receive line, one at a time, continuously over time, wherein each antenna of the plurality of antennas is either transmitting or receiving.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an RRU (remote radio unit) and a BBU (baseband unit) of a mobile network, according to an embodiment.

FIG. 2 shows a block diagram of an RRU, according to an embodiment.

FIG. 3 shows a timing diagram of controls of switches of the RRU of FIG. 2, according to an embodiment.

FIG. 4 shows a block diagram of a multiband TDD system (RRU), according to an embodiment.

FIG. 5 shows a frequency response of a transmit N-plexer and a frequency response of a receive N-plexer, according to an embodiment.

FIG. 6 shows a timing diagram of controls of switches of the RRU of FIG. 4, according to an embodiment.

FIG. 7 shows different beams formed for different frequency bands of an RRU, according to an embodiment.

FIG. 8 shows a block diagram of an RRU that includes greater transmit data traffic than receive data traffic, according to an embodiment.

FIG. 9 shows a timing diagram of controls of switches of the RRU of FIG. 8, according to an embodiment.

FIG. 10 shows a block diagram of a multiband TDD system (RRU) that includes greater transmit data traffic than receive data traffic, according to an embodiment.

FIG. 11 is a flow chart that includes steps of a method for operating of an RRU, according to an embodiment.

### DETAILED DESCRIPTION

The embodiments described include methods, apparatuses, and systems for a TDD (time division duplex) radio that provides for reduction in transmit and receive path resources. The described embodiments include an architecture where the TRX (transmit and receive) resources are reduced, and available resources are more efficiently used. Further, the TDD radio is operated without any loss of throughput. This reduction in resources is substantially beneficial in terms of BOM (bill of materials) cost and the space needed. Deployment of 5G wireless technologies is driving demand for mMIMO technology, and the described embodiments can be utilized to save money while reducing complexity of RRUs (remote radio units) utilized in the deployments. The described embodiments not only save BOM costs for LPTX and RX paths within RRUs, the described embodiments also reduce the memory and processing resources (for example, FPGA (field programmable gate arrays) within the RRUs. By utilizing the describes embodiments, the overall DC power consumption of an RRU is improve due to the lesser number of active paths and the reduced silicon resources. This additionally reduces the overall operational cost for the network operators and is better for the environment.

For the described embodiments, time division duplex (TDD) refers to duplex communication links where uplink (RRU wirelessly receive communications from a user) is separated from downlink (RRU wirelessly transmits communications to a user) by the allocation of different time slots in the same frequency band. Current TDD remote radio unit (RRU) base stations have one dedicated LPTX (low power transmit) path and a corresponding one dedicated RX (receiver) path for each antenna. For example, a typical 4T4R (Four transmit and four receive) macro base station has four dedicated LPTX paths and corresponding four RX paths. Similarly, an 8T8R macro base station has eight dedicated LPTX paths and corresponding eight RX paths, and for a 64T64R mMIMO (massive multi-input, multi-output) base station, there are 64LPTX path and corresponding 64 RX paths.

In a traditional TDD system, for a given Tx-RX chain pair, only one of the paths is used at a time. That is, when a radio is transmitting the corresponding receiving path is idle, and similarly, when the radio is receiving, the corresponding transmit path is idle. Initially, these TDD systems had equal uplink and downlink time slots. This way, the LPTX and the corresponding Rx paths were only used 50% of the time.

However, at least some of the described embodiments provide for use the LPTX path and RX path all the time except for when the paths are switching. This allows for a reduction of the LPTX, RX and corresponding FPGA resources by half, while still maintaining the same amount of data throughput. The described embodiments include connecting one LPTX and a corresponding RX path to two antenna modules (that include PAs (power amplifiers, and LNAs (low-noise amplifiers) through a SPDT (single pole, double throw) switch which can switch between the two antenna modules depending on which antenna of a plurality of antennas is transmitting or receiving.

Since in this case the uplink and downlink are utilized 50% of the time each, the LPTX/RX and FPGA resources can be reduced by half without any reduction in system throughput. At least some embodiments include an asymmetric flow for uplink and downlink data transmission. That is, for example, the downlink (RRU transmitting) may have more data transmission needs or requirements than the uplink (RRU receiving). For an embodiment, downlink and uplink transmission of users are allocated time slots for uplink and downlink transmission as needed. Using the described embodiments, for a TDD system with the 20% Uplink and 80% downlink, the uplink resources can be reduced by one fifth (⅕) and downlink resources can be reduced by four fifth (⅘) as compared to traditional TDD systems.

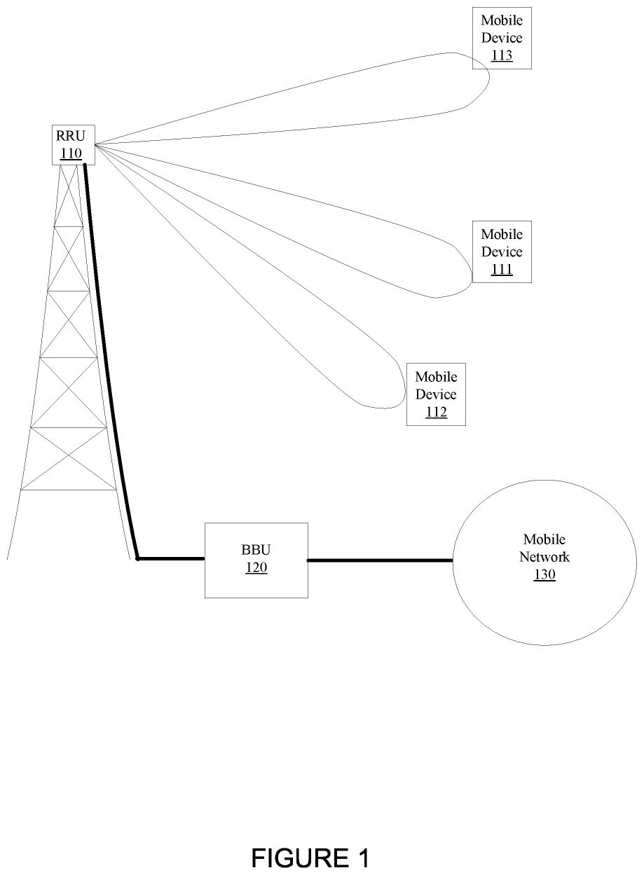

FIG. 1 shows an RRU (remote radio unit) 110 and a BBU (baseband unit) 120 of a mobile network 130, according to an embodiment. The mobile network 130 communicates with mobile devices 111, 112, 113 through the BBU and the RRU.

Traditional cellular, or Radio Access Networks (RAN), consist of many stand-alone base stations (BTS). For 3G (third generation of wireless mobile telecommunications technology), a distributed base station architecture was introduced by leading telecom equipment vendors. In this architecture the radio function unit, also known as the remote radio unit (RRU), is separated from the digital function unit, or baseband unit (BBU) by fiber. Digital baseband signals are carried over fiber, using the Open Base Station Architecture Initiative (OBSAI) or Common Public Radio Interface (CPRI) standard. The RRU can be installed on the top of tower close to the antenna, reducing the loss compared to the traditional base station where the RF signal has to travel through a long cable from the base station cabinet to the antenna at the top of the tower. The fiber link between RRH and BBU also allows more flexibility in network planning and deployment as they can be placed a few hundreds of meters or a few kilometers away. Most modern base stations now use this decoupled architecture.

A C-RAN (Cloud Radio Access Network) is made of a baseband unit (BBU), a remote radio unit (RRU), and a transport network that is also called a fronthaul. The BBU is a pool of centralized resources that function as a cloud or data center. The Remote Radio Unit (RRU) transmits RF signals and is connected to the Baseband Unit (BBU) through optical fibers. With advanced RF and antenna technologies, the RRU enables high-rate and low-latency data processing and significantly enhances eNodeB (3GPP's term for an LTE femtocell or Small Cell) capacity.

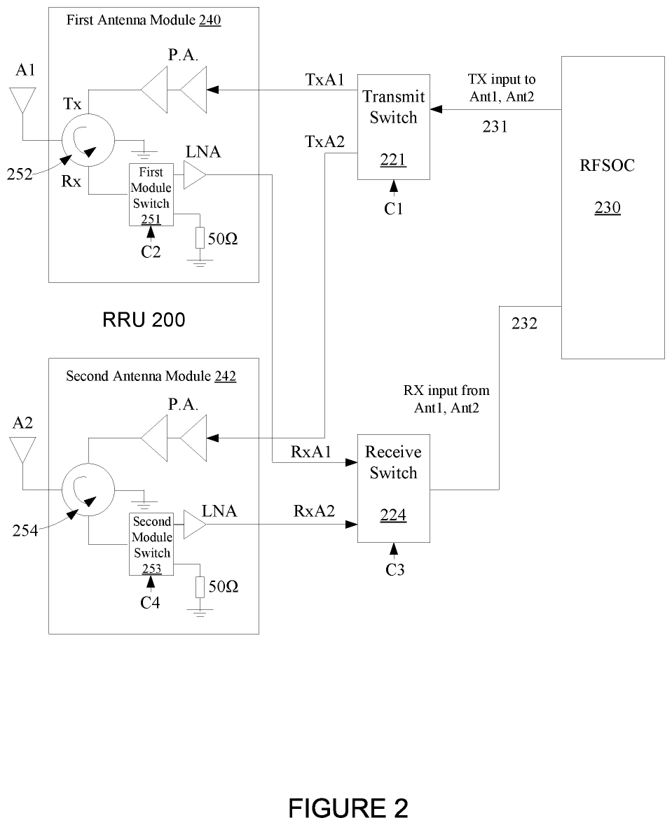

FIG. 2 shows a block diagram of an RRU 200, according to an embodiment. As shown, the RRU 200 includes an RF system on a chip (RFSOC) 230. For an embodiment, the RFSOC 230 includes baseband communication circuitry and frequency upconverters for transmit wireless signals and frequency downconverters for received wireless signals. The RRU 200 further includes a transmit switch 221. For an embodiment, the transmit switch 221 receives a plurality of transmit signals from the RFSOC 230 through single transmit line 231, and is operative to connect each of the plurality of transmit signals to a one of a plurality of antennas A1, A2, one at a time, continuously over time. The RRU 200 further includes a receive switch 224 receiving a plurality of received signals from the plurality of antennas A1, A2, and operative to connect each of the plurality of received signals to the RFSOC 230 on a single receive line 232, one at a time, continuously over time. For an embodiment, each antenna of the plurality of antennas A1, A2 is either transmitting or receiving at all times.

For an embodiment, the RRU 200 further includes a first antenna module 240 and a second antenna module 242. The first antenna module 240 and the second antenna module 242 operate as interfaces between the plurality of antennas A1, A2 and the transmit switch 221 and the receive switch 224.

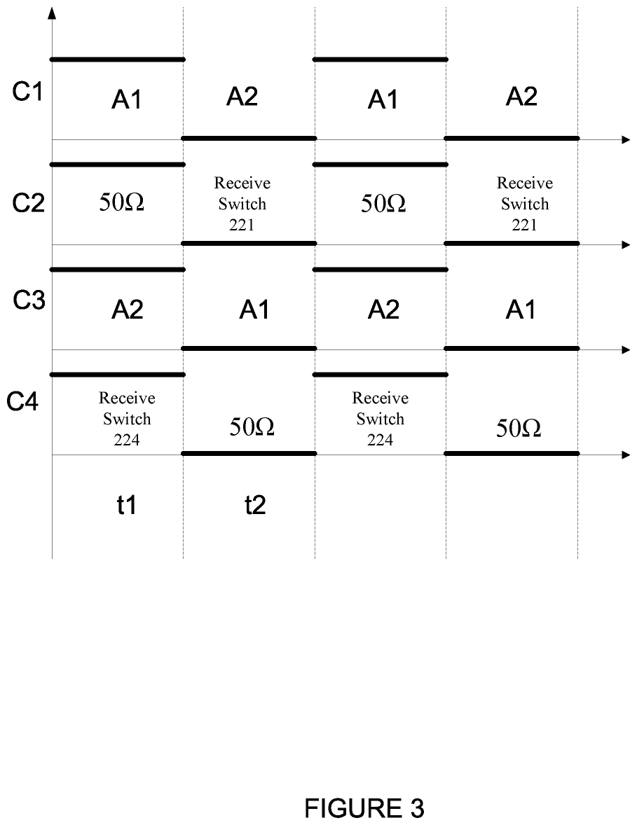

For an embodiment, the first antenna module 240 includes a circulator 252 configured to couple a first transmit signal of the transmit switch 221 to a first antenna A1 of the plurality of antennas A1, A2, and couple a first received signal of the first antenna A1 of the plurality of antennas A1, A2 to a first module switch 251. For an embodiment, the first module switch 251 is configured to connect an input to the first module switch 251 to a matched impedance (shown as 50Ω) during a first period of time (t1 in FIG. 3), and connect the first received signal of the first antenna A1 of the plurality of antennas A1, A2 to the receive switch 224 during a second period of time (t2 in FIG. 3).

For an embodiment, the second antenna module includes a second circulator 254 configured to couple a second transmit signal of the transmit switch 221 to a second antenna A2 of the plurality of antennas A1, A2, and couple a second received signal of the second antenna A2 of the plurality of antennas A1, A2 to a second module switch 253. For an embodiment, the second module switch 253 is configured to connect an input to the second module switch 253 to a matched impedance (shown as 50Ω) during the second period of time (t2 in FIG. 3), and connect the second received signal of the second antenna A2 of the plurality of antennas A1, A2 to the receive switch 224 during the first period of time (t1 in FIG. 3).

FIG. 3 shows a timing diagram of controls C1, C2, C3, C4 of switches 221, 224, 251, 253 of the RRU 200 of FIG. 2, according to an embodiment. The timing of the switching provided by each of the controls C1, C2, C3, C4 are synchronized. For an embodiment, the transmit switch 221 is configured to connect the first transmit signal TxA1 to the first antenna A1 through the first antenna module 240 during the first period (t1), and configured to connect the second transmit signal TxA2 to the second antenna A2 through the second antenna module 242 during the second period (t2). For an embodiment, the receive switch 224 is configured to connect the first received signal RxA1 of the first module 240 to the RFSOC 230 to during the second period (t2), and configured to connect the second received signal RxA2 of the second antenna module 242 to the RFSOC 230 during the first period (t1).

As shown in FIG. 3, for an embodiment, the control C1 connects the input (Tx) of the transmit switch 221 to the transmit chain connected to the first antenna A1 during the first period (T1), and connects the input (Tx) of the transmit switch 221 to the transmit chain connected to the second antenna A2 during the second period (T2). Further, the control C2 of the first module switch 251 synchronously controls the first module switch 251 to select the output of the first module switch 251 to the match impedance during the first period of time (while the transmit switch 221 is connected to the antenna T1. Further, the control C2 of the first module switch synchronously controls the first module switch 251 to connect the output of the first module switch 251 to the receive switch 224 while the antenna A1 is receiving rather than transmitting.

As shown in FIG. 3, for an embodiment, the control C3 connects the received signal of antenna A2 (RxA2) to the RFSOC 230 through the line 232 during the first period of time t1, and connects the received signal of antenna A1 (RxA1) to the RFSOC 230 through the line 232 during the second period of time t2. Again, the control of C3 is synchronous with the control of C1, C2, and C4. Further, the control C4 of the second module switch 251 synchronously controls the first module switch 251 to select the output of the first module switch 251 to the match impedance during the first period of time (while the transmit switch 221 is connected to the antenna T1. Further, the control C2 of the first module switch synchronously controls the first module switch 251 to connect the output of the first module switch 251 to the receive switch 224 while the antenna A1 is receiving rather than transmitting.

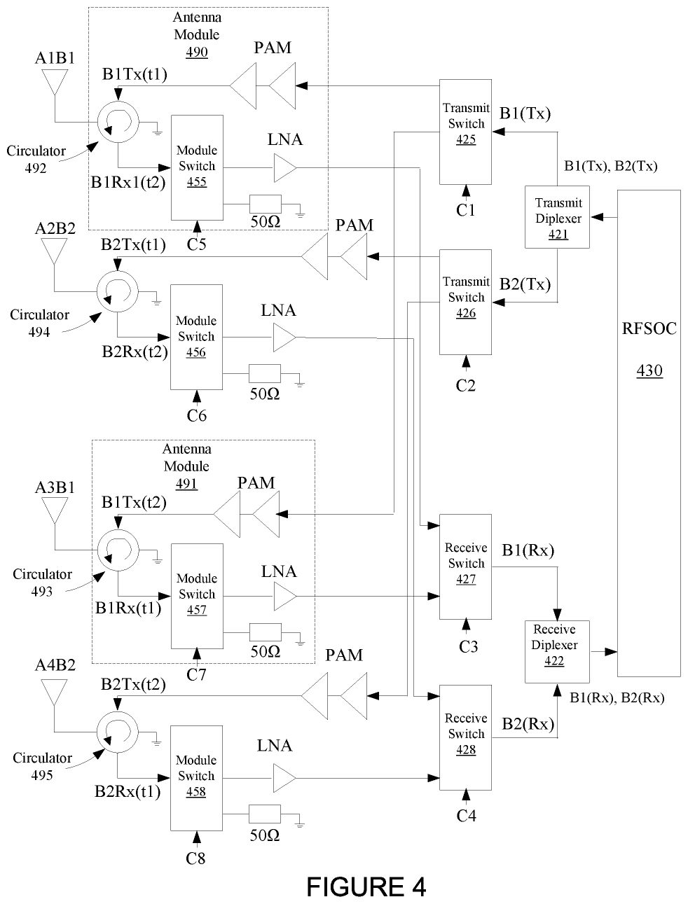

FIG. 4 shows a block diagram of a multiband TDD system (RRU), according to an embodiment. The embodiment of FIG. 4 further includes a plurality transmit switches 425, 426 associated with each transmit multiplexer 421. While only one transmit multiplexer 421 is shown in FIG. 4, it is to be understood that at least some embodiments include multiple transmit multiplexers.

For an embodiment, the first transmit switch 425 of the plurality of transmit switches 425, 426 operates (or is configured to) to connect a first band (B1(Tx)) of the multiple transmission frequency bands (B1(Tx), B2(Tx)) to a first transmitter chain (which feeds or is connected to antenna A1B1) of the plurality of transmitter chains or connect the first band (B1(Tx)) of the multiple transmission frequency bands (B1(Tx), B2(Tx)) to a third transmitter chain (which feeds or is connected to antenna A3B1) of the plurality of transmitter chains.

For an embodiment, the second transmit switch 426 of the plurality of transmit switches 425, 426 operates (or is configured to) to connect a second band (B2(Tx)) of the multiple transmission frequency bands (B1(Tx), B2(Tx)) to a second transmitter chain (which feeds or is connected to antenna A2B2) of the plurality of transmitter chains or connect the second band (B2(Tx)) of the multiple transmission frequency bands (B1(Tx), B2(Tx)) to a fourth transmitter chain (which feeds or is connected to antenna A4B2) of the plurality of transmitter chains.

Again, while only two transmit frequency bands (B1(Tx), B2(Tx)) are shown in FIG. 4, it is to be understood that at least some embodiments further include N transmit frequency bands.

The embodiment of FIG. 4 further includes a plurality receiver switches 427, 428 associated with each receive multiplexer 422. While only one receive multiplexer 422 is shown in FIG. 4, it is to be understood that at least some embodiments include multiple transmit multiplexers.

For an embodiment, the first receiver switch 427 of the plurality of receiver switches 427, 428 operates to connect a first band (B1(Rx) of the multiple receiver frequency bands (B1(Rx, B2(Rx)) from a first receive chain (which fed by or is connected to antenna A1B1) of the plurality of receiver chains associated (that is, corresponds with) with the first transmitter chain or connects the first band (B1(Rx) of the multiple transmission frequency bands (B1(Rx, B2(Rx)) from a third receiver chain (which fed by or is connected to antenna A3B1) of the plurality of receiver chains associated with the third transmitter chain to the receive multiplexer 422.

For an embodiment, the second receiver switch 428 of the plurality of receiver switches 427, 428 operates to connect a second band (B2(Rx) of the multiple receiver frequency bands (B1(Rx, B2(Rx)) from a second receiver chain (which fed by or is connected to antenna A2B2) of the plurality of receiver chains associated with the second transmitter chain or connect the second band (B2(Rx) of the multiple receive frequency bands (B1(Rx, B2(Rx)) from a fourth receiver chain (which fed by or is connected to antenna A4B2) of the plurality of receiver chains associated with the fourth transmitter chain to the receive multiplexer 422.

Again, while only two receive frequency bands (B1(Rx), B2(Rx)) are shown in FIG. 4, it is to be understood that at least some embodiments further include N receive frequency bands.

FIG. 4 further includes antenna modules associated with each of the antennas A1B1, A2B2, A3B1, A4B2. Two such antenna modules 490, 491 are shown in FIG. 4.

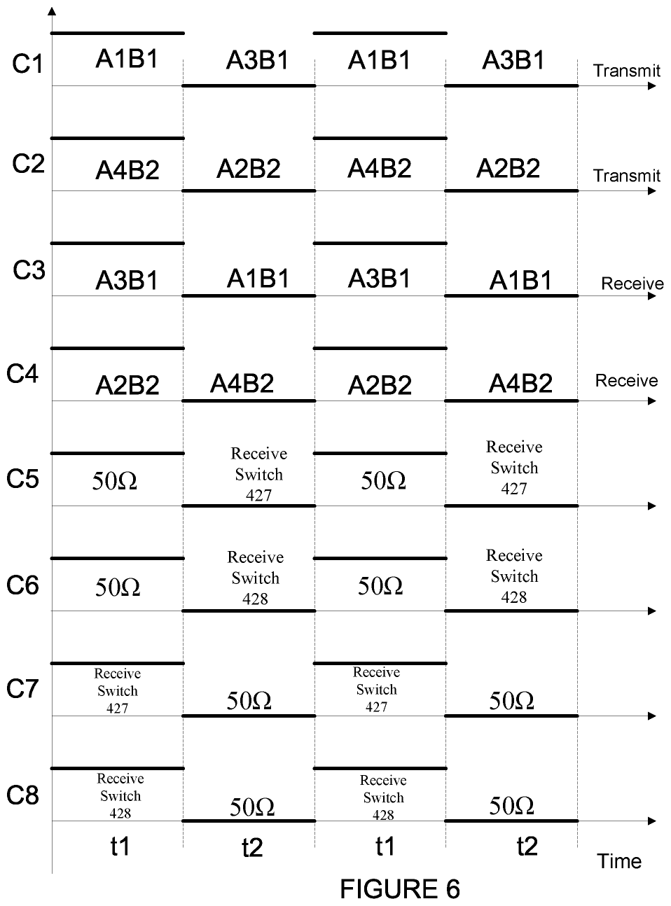

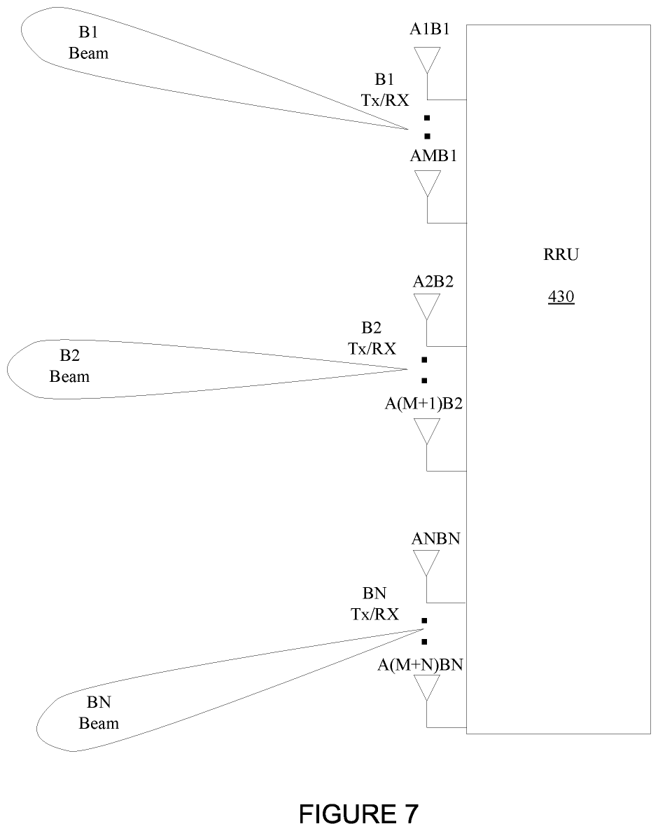

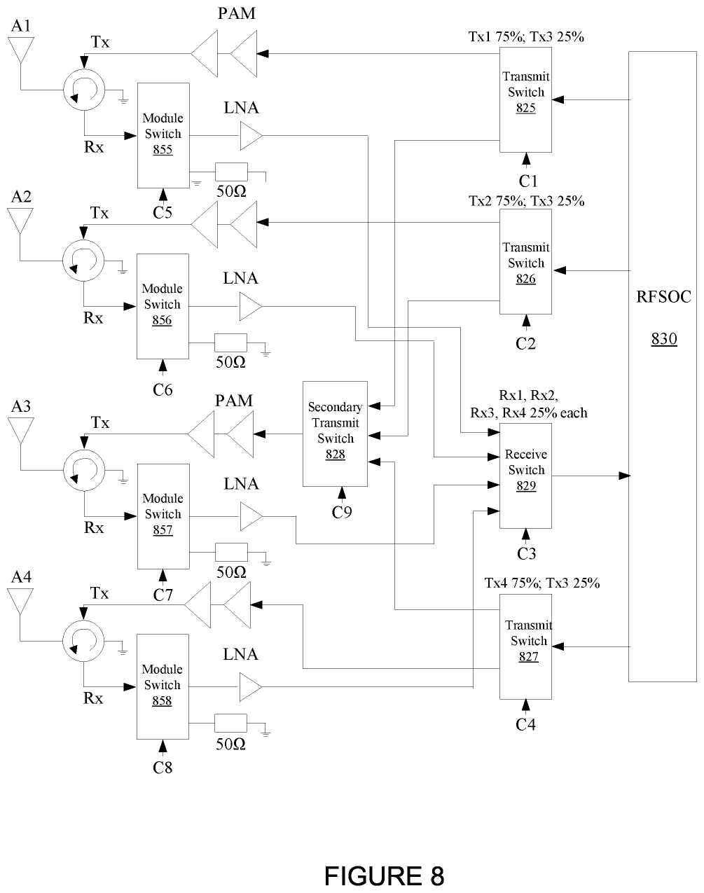

For an embodiment, a first antenna module 490 includes a first circulator 492 configured to couple a first transmit signal B1Tx(t1) of the first transmit switch 425 to the first antenna A1B1 of the plurality of antennas, and couple a first receive signal B1Rx(t2) of the first antenna A1B1 of the plurality of antennas to the first receive switch 427 through a first module switch 455. Further, for at least some embodiments, the first module switch 455 is configured to connect an input (an output of the circulator 492) to the first module switch 455 to a matched impedance (designated as 50Ω) during a first period of time (designated as t1 in FIG. 6), and connect the first receive signal B1(Rx) of the first antenna (A1B1) of the plurality of antennas to the first receive switch 427 during a second period of time (designated as t2 in FIGS. 7 and 8).

For an embodiment, a second antenna module 491 includes a second circulator 493 configured to couple a second transmit signal B1Tx(t2) of the first transmit switch 425 to a second antenna (A3B1) of the plurality of antennas, and couple a second receive signal B1Rx(t1) of the second antenna A3B1 of the plurality of antennas to the first receive switch 427 through a second module switch 457. Further, for at least some embodiments, the second module switch 457 is configured to connect an input to the second module switch to a matched impedance (designated as 50Ω) during the second period of time (designated as t2 in FIGS. 7 and 8), and connect the second received signal B1Rx(t1) of the second antenna (A3B1) of the plurality of antennas to the first receive switch 427 during the first period of time (designated as t1 in FIGS. 7 and 8).

The second transmit switch 426 and the second receive switch 428 operate in a similar fashion as described for the first transmit switch 425 and the first receive switch 427. The second transmit switch 426 and the second receive switch 428 are controllably operated with antenna modules associated with the antennas A2B2, A4B2, wherein the antenna modules associated with antennas A2B2, A4B2 include circulators 494, 495 and module switches 456, 458.

As shown, the first and second transmit switches 425, 427, and first and second receive switches 426, 428 are controlled by C1, C2, C3, C4. Further, module switches 455, 456, 457, 458 are controlled by C5, C6, C7, C8. Timing of the controls C1, C2, C3, C4, C5, C6, C7, C8 are shown in FIG. 6.

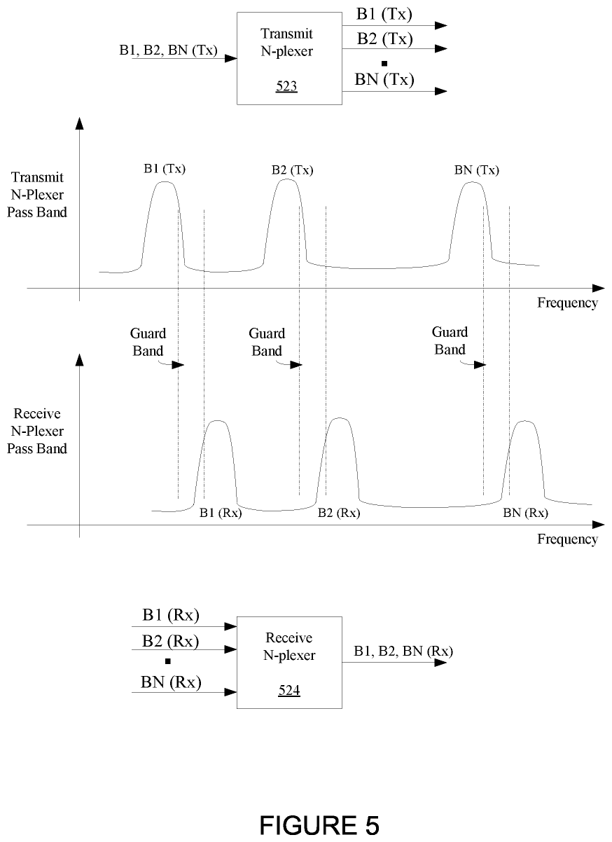

FIG. 5 shows a frequency response of a transmit N-plexer 523 and a frequency response of a receive N-plexer 525, according to an embodiment. For an embodiment, the diplexers 421, 422 are 3-port device that have a common port (Port1) and 2 different frequency ports (Port2 and Port3). The diplexer is bi-directional device and can be used in both transmit and receive scenarios. For the transmit diplexer 421, a combined multiple band signal (B1 (Tx), B2 (Tx)) in the frequency domain is input at the common port (Port1) and only the respective/individual band signals (B1(Tx), B2(Tx)) are obtained separately at the output of the diplexer (Port2 & Port3). The amount of rejection and fidelity between the bands depends on the design quality of the diplexer and the requirements. At the common port, since the desired signal is multi-band, the input return loss of this port must be good over the combined range of the multiband signal. Similarly, at the individual ports the return loss must be good over the respective frequency bands.

For the receive diplexer 422, only individual band signals (B1, B2 (Rx)) are input at the respective band ports (Port2 & Port3) and the combined multi-band signal is obtained at the common port (Port1)

For at least some embodiments, the N-plexers are (N+1) port device that have a common port (Port1) and multiple different frequency ports (Port2, Port3 . . . Port(N+1)). The multiplexer is bi-directional device and can be used in both transmission and reception of wireless signals.

For the transmit N-plexers, a combined multiple band signal (B1, B2, . . . BN) in the frequency domain is input at the common port (Port1) and only the respective/individual band signals (B1, B2, . . . BN) are obtained separately at the output of the multiplexer (Port2, Port3 . . . Port(N+1)). The amount of rejection and fidelity between the bands depends on the design quality of the diplexer and the requirements. At the common port, since the desired signal is multi-band, the input return loss of this port must be good over the combined range of the multi-band signal (B1, B2, . . . BN). Similarly, at the individual ports the return loss must be good over the respective frequency bands.

For the receive N-plexers, only individual band signals (B1, B2, . . . BN) are input at the respective band ports (Port2, Port3 . . . Port(N+1)) and the combined multi-band signal (B1, B2, . . . BN) is obtained at the common port (Port1).

FIG. 5 shows an exemplary transmit N-plexer 523 that receives the single input that includes the N bands (B1, B2, . . . BN) at the common port and generates the N separate outputs B1 (Tx), B2 (Tx), . . . BN (Tx). A corresponding frequency response of the pass bands of the exemplary transmit N-plexer 523 is shown below the exemplary transmit N-plexer 523. The passband includes passbands at B1 (Tx), B2 (Tx), . . . BN (Tx).

FIG. 5 also shows an exemplary receive N-plexer 524 the receives the N separate receive signals B1 (Rx), B2 (Rx), . . . BN (Rx) and generates the single output that includes the N bands B1 (Rx), B2 (Rx), . . . BN (Rx). A corresponding frequency response of the pass bands of the exemplary receive N-plexer 524 is shown above the exemplary receive N-plexer 524. The passband includes passbands at B1 (Rx), B2 (Rx), . . . BN (TRx). A guard band is between each of the transmit bands B1 (Tx), B2 (Tx), . . . BN (Tx) and the receive bands B1 (Rx), B2 (Rx), . . . BN (Rx). The guard band includes a small portion of the frequency domain that is allocated between the transmit signals and the receive signals within a band. For example, the guard band is located in the frequency domain between the passbands of B1(Tx) and B1(Rx), between the passbands of B2(Tx) and B2(Rx), and between the passbands of BN(Tx) and BN(Rx).

FIG. 6 shows a timing diagram of controls of switches of the RRU of FIG. 4, according to an embodiment. C1 controls the switch settings of the first transmit switch 425. C2 controls the switch settings of the second transmit switch 426. C3 controls the switch settings of the first receive switch 427. C4 controls the switch settings of the second receive switch 428. C5 controls the switch settings of the module switch 455. C6 controls the switch settings of the module switch 456. C7 controls the switch settings of the module switch 457. C8 controls the switch settings of the module switch 458.

As shown and as will be described, the embodiment of FIG. 4 greatly reduces transmit and receive path resources because two transmit chains and two receive chains are supported by a single transmit connection and a single receive connection to the RFSOC 430. Further, while only a single transmit duplexer 421 and a single receive diplexer 422 are shown, other embodiments include more than the single transmit duplexer 421 and a single receive diplexer 422. Further, while only two transmit bands (B1(Tx), B2(Tx)) and two receive bands (B1(Rx), B2(Rx)) are shown, other embodiments include more transmit and receive bands.

For at least some embodiments, the first transmit switch 425 is controlled by C1 to connect the first transmit signal (B1(Tx) at t1) to the first antenna A1B1 through the first antenna module 490 during the first period (t1), and configured to connect the second transmit signal (B1(T(x) at time t2) to the second antenna A3B1 through the second antenna module 491 during the second period (t2). That is, during the first time periods (t1) the first transmit switch is controlled by C1 to connect B1(Tx) to antenna A1B1, and during the second time periods (t2) the first transmit switch 425 is controlled by C1 to connect B1(Tx) to antenna A3B1.

Further, for at least some embodiments, the first receive switch 427 is controlled by C3 to connect the first receive signal (B1(Rx at t1) of the second module 491 to the RFSOC 430 to during the first period (t1), and configured to connect the second received signal (B1(Rx) at t2) of the first antenna module 490 to the RFSOC 430 during the second period (t2).

Further, for at least some embodiments, the second transmit switch 426 is controlled by C2 to connect a third transmit signal (B2(Tx) at t1) to a third antenna A2B3 through a third antenna module (not shown) during the first period (t1), and configured to connect a fourth transmit signal (B2(T(x) at time t2) to a fourth antenna A4B2 through a fourth antenna module (not shown) during the second period (t2). That is, during the first time periods (t1) the second transmit switch 426 is controlled by C2 to connect B2(Tx) to antenna A2B2, and during the second time periods (t2) the second transmit switch 426 is controlled by C2 to connect B2(Tx) to antenna A4B2.

Further, for at least some embodiments, the second receive switch 428 is controlled by C4 to connect a third receive signal (B2(Rx at t1) of the third module to the RFSOC 430 to during the first period (t1), and configured to connect a fourth received signal (B2(Rx) at t2) of the third antenna module to the RFSOC 430 during the second period (t2).

As shown, the module switches 455, 456, 457, 458 are controlled by C5, C6, C7, C8, wherein the control is synchronized with the control of the transmit switches 425, 426 and the receive switches 427, 428. For an embodiment, the module switch 455 of the first antenna module 490 is controlled by C5 to connect the output of the module switch 455 to a matched impedance (shown as 50Ω) during the first period t1. That is, the transmit switch 425 is controlled by C1 to connect the first transmit signal (B1(Tx) at t1) to the first antenna A1B1 through the first antenna module 490 during the first period (t1). Accordingly, the first antenna A1B1 is transmitting the first transmit signal (B1(Tx) at t1), and the output of the circulator 492 is connected to the matched impedance. For an embodiment, the module switch 455 of the first antenna module 490 is controlled by C1 to connect the output of the module switch 455 to the receive switch 427 during the second periods of time. That is, the first receive switch 427 is controlled by C3 to connect the second received signal (B1(Rx) at t2) of the first antenna module 490 to the RFSOC 430 during the second periods (t2). Accordingly, the first antenna A1B1 is receiving the second received signal (B1(Rx) at t2), and the output of the circulator 492 should be connected to the receive switch 427.

For an embodiment, the module switch 457 of the second antenna module 491 is controlled to connect the output of the module switch 457 to the receive switch 427 during the first periods of time. That is, the first receive switch 427 is controlled by C3 to connect the received signal (B1(Rx) at t1) of the third antenna module 491 to the RFSOC 430 during the first periods (t1). Accordingly, the first antenna A3B1 is receiving the received signal (B1(Rx) at t1), and the output of the circulator 493 should be connected to the receive switch 427. For an embodiment, the module switch 457 of the second antenna module 490 is controlled by C7 to connect the output of the module switch 457 to a matched impedance (shown as 50Ω) during the second periods t2. That is, the transmit switch 427 is controlled by C3 to connect the second transmit signal (B1(Tx) at t2) to the second antenna A3B1 through the second antenna module 491 during the second period (t2). Accordingly, the second antenna A3B2 is transmitting the second transmit signal (B1(Tx) at t2), and the output of the circulator 493 should be connected to the matched impedance.

FIG. 7 shows different beams formed for different frequency bands of an RRU, according to an embodiment. For an embodiment, the transmit signals generate a separate transmission beam for each of the multiple transmission frequency bands, and a corresponding reception beam for one of the multiple receive frequency bands. FIG. 4 shows the antennas of A1B1, A2B2, . . . ANBN, and antennas AMB1, A(M+1)B2, . . . A(M+N)BN rearranged to illustrate that the multiple antennas dedicated to each of the bands B1, B2, . . . BN provides or allows for a separate beam to be formed for each of the bands. Therefore, a separate direction for each of the directional bands can be realized for each of the N bands B1, B2, . . . BN. For an embodiment, the directional beam (B1 Beam, B2 Beam, BN Beam) for each of the N bands B1, B2, . . . BN is realized or formed for both the transmit bands B1, B2, . . . BN (Tx) and the receive bands B1, B2, . . . B3 (Rx). The beam directions for each of the separate bands can be controlled by selecting phase and amplitude adjustments for the multiple transmit and receive signals for each of the transmit bands B1, B2, . . . BN (Tx) and the receive bands B1, B2, . . . B3 (Rx).

FIG. 8 shows a block diagram of an RRU that includes greater transmit data traffic than receive data traffic, according to an embodiment. As shown, this embodiment includes three transmit switches 825, 826, 827 and one receive switch 829. It is to be understood the equivalent implementation include different numbers of transmit switches and receive switches. For a least some embodiments, the number of transmit switches is greater that the number of receive switches when the RRU is to be used for transmitting wireless communication a majority of time, and the number of receive switches will be greater when the RRU is to be used for receiving wireless communication the majority of the time.

For this embodiment, the transmit switch 825 controls the 75% timing distribution of the output of the RFSOC 830 to antenna A1, and the 25% timing distribution to antenna A3 through secondary transmit switch 828. The transmit switch 826 controls the 75% timing distribution of the output of the RFSOC 830 to antenna A2, and the 25% timing distribution to antenna A3 through the secondary transmit switch 828. The transmit switch 827 controls the 75% timing distribution of the output of the RFSOC 830 to antenna A4, and the 25% timing distribution to antenna A3 through the secondary transmit switch 828.

The receive switch 829 receives the received signals from the antennas A1, A2, A3, A4 at a time duration of 25% each. The antennas A1, A2, A3, A4 are operative to transmit 75% of the time, and receive wireless signals that are each coupled to the receive switch 829 25% of the time. The antennas A1, A2, A3, A4 are operative to transmit 75% of the time, and receive wireless signals that are each coupled to the receive switch 829 25% of the time. The outputs of the receive switch 829 is connected to the RFSOC 830 over a single line.

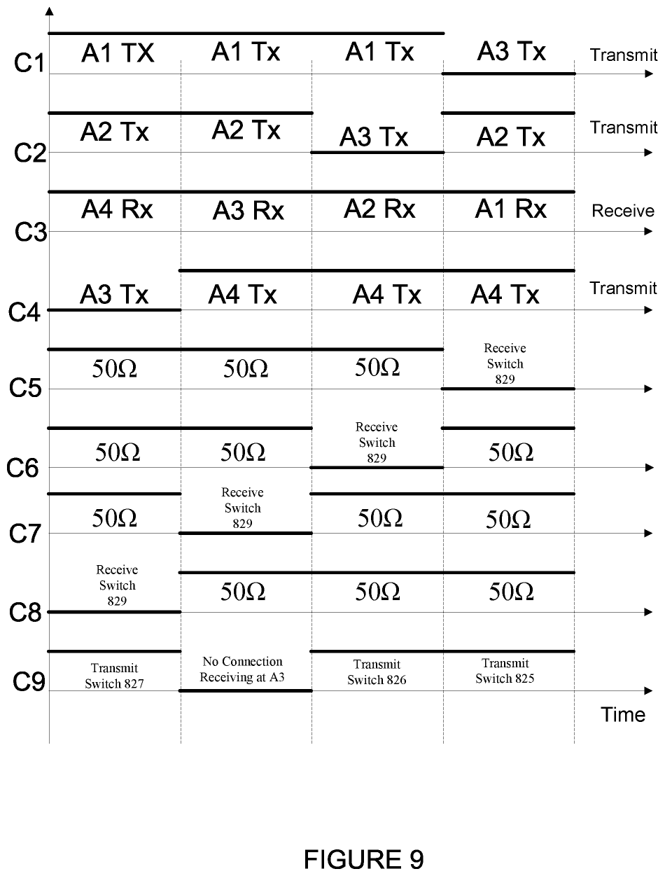

FIG. 9 shows a timing diagram of controls of switches of the RRU of FIG. 8, according to an embodiment. The control C1 controls the output of transmit switch 825 being connected to the antenna A1 for 3 out of four time periods, or the antenna A3 for one out of four time periods. The control C2 controls the output of transmit switch 826 being connected to the antenna A2 for 3 out of four time periods, or the antenna A3 for one out of four time periods. The control C4 controls the output of transmit switch 827 being connected to the antenna A4 for 3 out of four time periods, or the antenna A3 for one out of four time periods.

The control C4 controls the output of receive switch 829 being connected to receive from the antenna A1 for 1 out of four time periods, receive from the antenna A2 for 1 out of four time periods, receive from the antenna A3 for 1 out of four time periods, or receive from the antenna A4 for one out of four time periods.

The controls C5, C6, C7, C8 are controlled to connect the outputs of the module switches 855, 856, 857, 858 to the matched impedance (50Ω) while the antenna associated with each module switch is transmitting, connect the outputs of the module switches 855, 856, 857, 858 to the receive switch 829 while the antenna associated with each module switch is receiving.

The control C9 controls the secondary transmit switch 828 to connect a one of the transmit switches 825, 826, 827 to the antenna A3 a needed to maintain continuous transmission through the transmit switches 825, 826, 827.

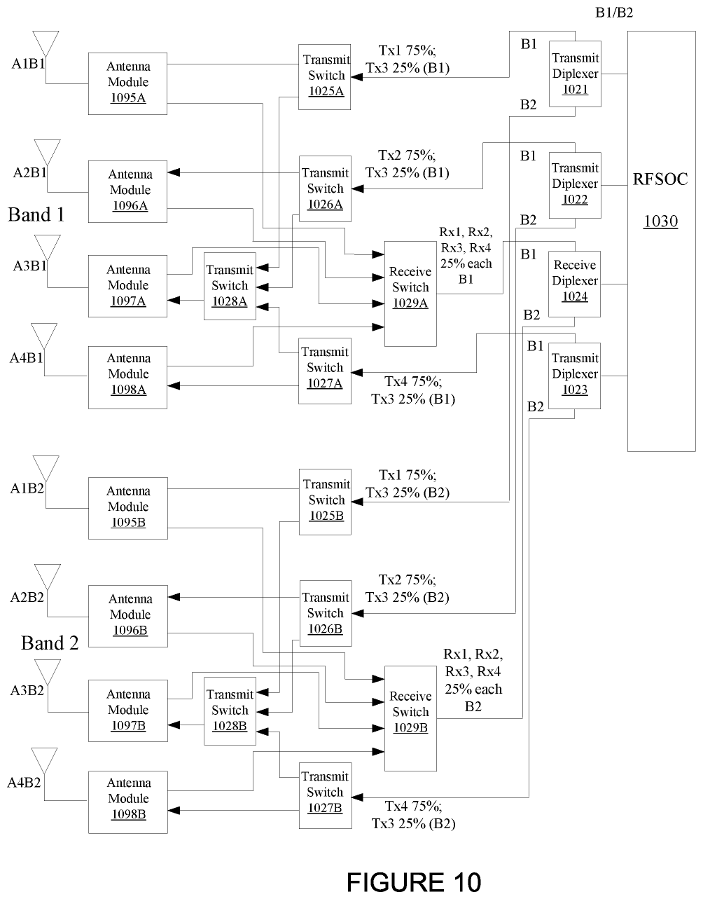

FIG. 10 shows a block diagram of a multiband TDD system (RRU) that includes greater transmit data traffic than receive data traffic, according to an embodiment. In some situation it may be determined that a particular RRU will be primarily transmitting data traffic rather than receiving data traffic, or determined to be primarily receiving data traffic rather than transmitting data traffic. These asymmetrical wireless link communication systems can be accommodated by including more transmit multiplexers than receive multiplexers, or more receive multiplexers than transmit multiplexers, and more transmit switches than receive switches, or more receive switches than transmit switches. For an embodiment, the system includes more transmit multiplexer when the system is configured to transmit wireless communication a majority of time, and wherein the system includes more receive multiplexers when the system is configured to receive wireless communication a majority of time.

The block diagram of FIG. 10 includes transmit multiplexers 1021, 1022, 1023, wherein each of the plurality of transmit multiplexers 1021, 1022, 1023 receives transmit signals from the RFSOC 1030 through a single transmit line and generates transmit signals for a sub-plurality of the transmitter chains through multiple transmit lines, wherein the transmit signals include multiple transmission frequency bands (B1, B2). As shown, a first transmit multiplexer 1021 receives through a single line a band 1 (B1) signal with 75% of the time dedicated to antenna A1B1 and 25% of the time dedicated antenna A3B1, and a band 2 (B2) signal with 75% of the time dedicated to antenna A1B2 and 25% of the time dedicated antenna A3B2. The transmit diplexer 1021 generates the B1 signal for antennas A1B1 and A3B1, and generates the B2 signal for antenna A1B2 and A3B2.

As shown, a second transmit multiplexer 1022 receives through a single line a band 1 (B1) signal with 75% of the time dedicated to antenna A2B1 and 25% of the time dedicated antenna A3B1, and a band 2 (B2) signal with 75% of the time dedicated to antenna A2B2 and 25% of the time dedicated antenna A3B2. The transmit diplexer 1021 generates the B1 signal for antennas A2B1 and A3B1, and generates the B2 signal for antenna A2B2 and A3B2.

As shown, a third transmit multiplexer 1023 receives through a single line a band 1 (B1) signal with 75% of the time dedicated to antenna A4B1 and 25% of the time dedicated antenna A3B1, and a band 2 (B2) signal with 75% of the time dedicated to antenna A4B2 and 25% of the time dedicated antenna A3B2. The transmit diplexer 1021 generates the B1 signal for antennas A4B1 and A3B1, and generates the B2 signal for antenna A4B2 and A3B2.

The block diagram of FIG. 10 includes 6 transmit switches 1025A, 1026A, 1027A, 1025B, 1026B, 1027B. The transmit switch 1025A receives the Band 1 (B1) output of the first transmit diplexer 1021, and controls the 75% timing distribution of the output of the Band 1 (B1) output of the first transmit diplexer 1021 to antenna A1B1 through the antenna module 1095A, and the 25% timing distribution to antenna A3B1 through secondary transmit switch 1028A and through the antenna module 1097A. The transmit switch 1026A receives the Band 1 (B1) output of the second transmit diplexer 1022, and controls the 75% timing distribution of the output of the Band 1 (B1) output of the second transmit diplexer 1022 to antenna A2B1 through the antenna module 1096A, and the 25% timing distribution to antenna A3B1 through the secondary transmit switch 1028A and through the antenna module 1097A. The transmit switch 1027A receives the Band 1 (B1) output of the third transmit diplexer 1023, and controls the 75% timing distribution of the output of the Band 1 (B1) output of the third transmit diplexer 1023 to antenna A4B1 through the antenna module 1098A, and the 25% timing distribution to antenna A3B1 through the secondary transmit switch 1028A and through the antenna module 1097A.

The transmit switch 1025B receives the Band 2 (B2) output of the first transmit diplexer 1021, and controls the 75% timing distribution of the output of the Band 2 (B2) output of the first transmit diplexer 1021 to antenna A1B2 through the antenna module 1095B, and the 25% timing distribution to antenna A3B2 through secondary transmit switch 1028B and through the antenna module 1097B. The transmit switch 1026B receives the Band 2 (B2) output of the second transmit diplexer 1022, and controls the 75% timing distribution of the output of the Band 2 (B2) output of the second transmit diplexer 1022 to antenna A2B2 through the antenna module 1096B, and the 25% timing distribution to antenna A3B2 through the secondary transmit switch 1028B and through the antenna module 1097B. The transmit switch 1027B receives the Band 2 (B2) output of the third transmit diplexer 1023, and controls the 75% timing distribution of the output of the Band 2 (B2) output of the third transmit diplexer 1023 to antenna A4B2 through the antenna module 1098B, and the 25% timing distribution to antenna A3B2 through the secondary transmit switch 1028B and through the antenna module 1097B.

The block diagram of FIG. 10 includes 2 receive switches 1029A, 1029B. The receive switch 1029A receives the Band 1 (B1) receive signals from the antennas A1B1, A2B1, A3B1, A4B1 at a time duration of 25% each. The antennas A1B1, A2B1, A3B1, A4B1 are operative to transmit 75% of the time, and receive wireless signals that are each coupled to the receive switch 1029A 25% of the time. The receive switch 1029B receives the Band 2 (B2) receive signals from the antennas A1B2, A2B2, A3B2, A4B2 at a time duration of 25% each. The antennas A1B2, A2B2, A3B2, A4B2 are operative to transmit 75% of the time, and receive wireless signals that are each coupled to the receive switch 1029B 25% of the time.

The outputs of the receive switches 1029A, 1029B are connected to the receive multiplexer 1024 which provides the signals received over the two bands (B1, B2) to the RFSOC 1030 over a single line.

While the RRU of FIG. 10 includes more transmit diplexers than receive diplexers, it is to be understood that if the RRU will be deployed to receive communication more than the RRU transmits communication, an embodiment includes more receive diplexers than transmit diplexers. As previously described, each of the plurality of receive multiplexers receiving receive signals from a sub-plurality of the receiver chains through multiple receive lines and providing the receive signals to the RFSOC through a single receive line, wherein the receive signals include multiple receive frequency bands. A similar arrangement as shown for the greater amount of transmit diplexers of FIG. 10 can be created for the greater amount of receive diplexers.

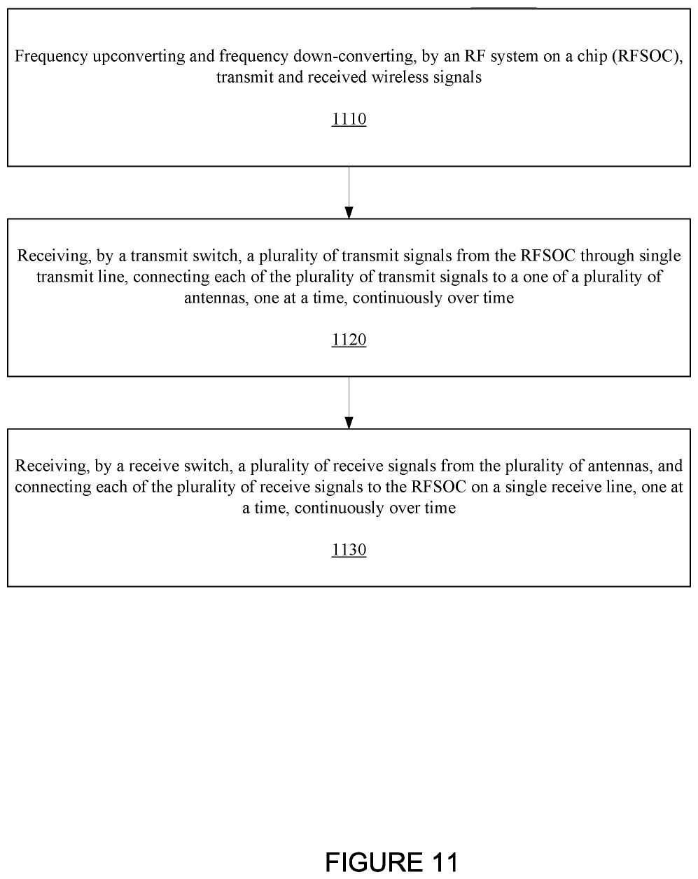

FIG. 11 is a flow chart that includes steps of a method for operating of an RRU, according to an embodiment. A first step 1110 includes frequency upconverting and frequency down-converting, by an RF system on a chip (RFSOC), transmit and received wireless signals. A second step 1120 includes receiving, by a transmit switch, a plurality of transmit signals from the RFSOC through single transmit line, connecting each of the plurality of transmit signals to a one of a plurality of antennas, one at a time, continuously over time. A third step 1130 includes receiving, by a receive switch, a plurality of received signals from the plurality of antennas, and connecting each of the plurality of received signals to the RFSOC on a single receive line, one at a time, continuously over time. For an embodiment, each antenna of the plurality of antennas is either transmitting or receiving.

An embodiment further includes coupling, by a circulator of a first antenna module, a first transmit signal of the transmit switch to a first antenna of the plurality of antennas, and coupling, by the circulator, a first received signal of the first antenna of the plurality of antennas to a first module switch. Further the first module switch connects an input to the first module switch to a matched impedance during a first period of time, and connecting, by the first module switch, the first received signal of the first antenna of the plurality of antennas to the receive switch during a second period of time.

An embodiment further includes coupling, by a second circulator of a second antenna module, a second transmit signal of the transmit switch to a second antenna of the plurality of antennas, and coupling, by the second circulator, a second received signal of the second antenna of the plurality of antennas to a receive switch. Further, the second module switch connects an input to the second module switch to a matched impedance during the second period of time, and connecting, by the second module switch, the second received signal of the second antenna of the plurality of antennas to the receive switch during the first period of time.

For at least some embodiments, the transmit switch is configured to connect the first transmit signal to the first antenna through the first antenna module during the first period, and configured to connect the second transmit signal to the second antenna through the second antenna module during the second period. For at least some embodiments, the receive switch is configured to connect the first received signal of the second module to the RFSOC to during the first period, and configured to connect the second received signal of the first antenna module to the RFSOC during the second period.

For an embodiment, a plurality of transmit switches include the transmit switch, and a plurality of receive switches include the receive switch. Further the method includes receiving, by each of one or more transmit multiplexers, transmit signals from the RFSOC through a single transmit line, and generating by each of the one or more transmit multiplexers, transmit signals for a sub-plurality of the transmitter switches through multiple transmit lines, wherein the transmit signals include multiple transmission frequency band, and receiving, by each of one or more receive multiplexers, received signals from a sub-plurality of the receiver switches through multiple receive lines, and providing, by each of one or more receive multiplexers, the received signals to the RFSOC through a single receive line, wherein the receive signals include multiple receive frequency bands.

As previously described, for an embodiment, the system includes more transmit multiplexers than receive multiplexers when the system is configured to transmit wireless communication a majority of time, and wherein the system includes more receive multiplexers than transmit multiplexers when the system is configured to receive wireless communication a majority of time.

As previously described, for an embodiment, the RFSOC is operable at a high enough frequency to process the transmit signals having the multiple frequency bands and the receive signals having the multiple frequency bands. As previously described, for an embodiment, a one of the transmitter switches operates to transmit a wireless signal through one of the multiple transmission frequency band simultaneous with a one of the receiver switches operating to receive a wireless signal through one of the multiple receive frequency bands.

Although specific embodiments have been described and illustrated, the embodiments are not to be limited to the specific forms or arrangements of parts so described and illustrated. The described embodiments are to only be limited by the claims.

What is claimed:

1. A system, comprising:
an RF system on a chip (RFSOC) comprising baseband communication circuitry and frequency upconverters for transmit wireless signals and frequency downconverters for received wireless signals;
a transmit switch receiving a plurality of transmit signals from the RFSOC through single transmit line, and operative to connect each of the plurality of transmit signals to a one of a plurality of antennas, one at a time, continuously over time; and
a receive switch receiving a plurality of received signals from the plurality of antennas, and operative to connect each of the plurality of received signals to the RFSOC on a single receive line, one at a time, continuously over time;
wherein each antenna of the plurality of antennas is either transmitting or receiving.

2. The system of claim 1, further comprising a first antenna module comprising:
a circulator configured to couple a first transmit signal of the transmit switch to a first antenna of the plurality of antennas, and couple a first received signal of the first antenna of the plurality of antennas to a first module switch;
the first module switch configured to connect an input to the first module switch to a matched impedance during a first period of time, and connect the first received signal of the first antenna of the plurality of antennas to the receive switch during a second period of time.

3. The system of claim 2, further comprising a second antenna module comprising:
a second circulator configured to couple a second transmit signal of the transmit switch to a second antenna of the plurality of antennas, and couple a second received signal of the second antenna of the plurality of antennas to a second module switch;
the second module switch configured to connect an input to the second module switch to a matched impedance during the second period of time, and connect the second received signal of the second antenna of the plurality of antennas to the receive switch during the first period of time.

4. The system of claim 3, wherein the transmit switch is configured to connect the first transmit signal to the first antenna through the first antenna module during the first period, and configured to connect the second transmit signal to the second antenna through the second antenna module during the second period.

5. The system of claim 3, wherein the receive switch is configured to connect the first received signal of the second module to the RFSOC to during the first period, and configured to connect the second received signal of the first antenna module to the RFSOC during the second period.

6. The system of claim 1, further comprising:
a plurality of transmit switches including the transmit switch;
a plurality of receive switches including the receive switch;
one or more transmit multiplexers;
one or more receive multiplexers;
wherein each of the one or more transmit multiplexers receive transmit signals from the RFSOC through a single transmit line and generates transmit signals for a sub-plurality of the plurality of transmitter switches through multiple transmit lines, wherein the transmit signals include multiple transmission frequency bands; and
wherein each of the one or more receive multiplexers receive received signals from a sub-plurality of the plurality of receiver switches through multiple receive lines and provides the received signals to the RFSOC through a single receive line, wherein the received signals include multiple receive frequency bands.

7. The system of claim 6, wherein the RFSOC is operable at a high enough frequency to process the transmit signals having the multiple frequency bands and the received signals having the multiple frequency bands.

8. The system of claim 6, wherein the transmit signals generate a separate transmission beam for each of the multiple transmission frequency bands, and a corresponding one of the multiple receive frequency bands.

9. The system of claim 6, wherein each of the transmit multiplexers include electronic circuitry for frequency matching at each of the multiple transmission frequency bands.

10. The system of claim 6, wherein each of the receive multiplexers include electronic circuitry for frequency matching at each of the multiple received frequency bands.

11. The system of claim 6, wherein each of the multiple transmission frequency bands has a corresponding one of the multiple receive frequency bands.

12. The system of claim 6, wherein the system comprises more transmit multiplexers than receive multiplexers when the system is configured to transmit wireless communication a majority of time, and wherein the system comprises more receive multiplexers than transmit multiplexers when the system is configured to receive wireless communication a majority of time.

13. The system of claim 11, wherein a one of the transmitter switches operates to transmit a wireless signal through one of the multiple transmission frequency band simultaneous with a one of the receiver switches operating to receive a wireless signal through one of the multiple receive frequency bands.

14. A method, comprising:
frequency upconverting and frequency down-converting, by an RF system on a chip (RFSOC), transmit and received wireless signals;
receiving, by a transmit switch, a plurality of transmit signals from the RFSOC through single transmit line, connecting each of the plurality of transmit signals to a one of a plurality of antennas, one at a time, continuously over time; and
receiving, by a receive switch, a plurality of received signals from the plurality of antennas, and connecting each of the plurality of received signals to the RFSOC on a single receive line, one at a time, continuously over time;
wherein each antenna of the plurality of antennas is either transmitting or receiving.

15. The method of claim 14, further comprising:
coupling, by a circulator of a first antenna module, a first transmit signal of the transmit switch to a first antenna of the plurality of antennas, and coupling, by the circulator, a first received signal of the first antenna of the plurality of antennas to a first module switch;
connecting, by the first module switch, an input to the first module switch to a matched impedance during a first period of time, and connecting, by the first module switch, the first received signal of the first antenna of the plurality of antennas to the receive switch during a second period of time.

16. The method of claim 15, further comprising:
coupling, by a second circulator of a second antenna module, a second transmit signal of the transmit switch to a second antenna of the plurality of antennas, and coupling, by the second circulator, a second received signal of the second antenna of the plurality of antennas to a second module switch;
connecting, by the second module switch, an input to the second module switch to a matched impedance during the second period of time, and connecting, by the second module switch, the second received signal of the second antenna of the plurality of antennas to the receive switch during the first period of time.

17. The method of claim 16, wherein the transmit switch is configured to connect the first transmit signal to the first antenna through the first antenna module during the first period, and configured to connect the second transmit signal to the second antenna through the second antenna module during the second period.

18. The method system of claim 17, wherein the receive switch is configured to connect the first received signal of the second module to the RFSOC to during the first period, and configured to connect the second received signal of the first antenna module to the RFSOC during the second period.

19. The method of claim 14, wherein a plurality of transmit switches include the transmit switch, and a plurality of receive switches include the receive switch, and further comprising:
receiving, by each of one or more transmit multiplexers, transmit signals from the RFSOC through a single transmit line, and generating by each of the one or more transmit multiplexers, transmit signals for a sub-plurality of the plurality of transmitter switches through multiple transmit lines, wherein the transmit signals include multiple transmission frequency bands; and
receiving, by each of one or more receive multiplexers, received signals from a sub-plurality of the plurality of receiver switches through multiple receive lines, and providing, by each of one or more receive multiplexers, the received signals to the RFSOC through a single receive line, wherein the receive signals include multiple receive frequency bands.

20. The method of claim 19, a number of transmit multiplexers is greater than a number of receive multiplexers when transmitting wireless communication a majority of time, and wherein the number receive multiplexers is greater than the number of transmit multiplexers when receiving wireless communication a majority of time.
